(19) United States
(12) Patent Application Publication
(10) Pub. No.: US 2006/0245317 A1
(43) Pub. Date: Nov. 2, 2006

(54) Optical head and information recording/reproducing apparatus

(76) Inventors: Katsuo Iwata, Yokohama-shi (JP); Kazuhiro Nagata, Yokohama-shi (JP); Yuuichi Nakamura, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/410,158

(22) Filed: Apr. 25, 2006

(30) Foreign Application Priority Data
Apr. 27, 2005 (JP) 2005-129859

(51) Int. Cl. G11B 7/00

(52) U.S. Cl. 369/44.11

(57) ABSTRACT

To provide an optical head unit which is configured to provide a reproduce signal when reproducing information from a recording medium of a corresponding standard by selectively using laser beams with different wavelengths, an optical diffraction element is provided, in which the grooves of a binary diffraction grating mainly for a laser beam with a wavelength of 655 nm and a blazed diffraction grating mainly for a laser beam with a wavelength of 405 nm are defined substantially parallel, and the reflected laser beams of the laser beams with respective wavelengths reflected by a corresponding optical disc are guided to a substantially the same detection area or detection areas positioned very close to one another in a photodetector.

### CROSS-REFERENCE TO RELATED APPLICATIONS

This application is based upon and claims the benefit of priority from Japanese Patent Application No. 2005-129859, filed Apr. 27, 2005, the entire contents of which are incorporated herein by reference.

### BACKGROUND

1. Field

One embodiment of the invention relates to an information recording/reproducing apparatus which records or reproduces back information in/from an optical information recording medium or an optical disc, and an optical head incorporated in the information recording/reproducing apparatus.

2. Description of the Related Art

A long time has been passed since the commercialization of an optical disc capable of recording or reproducing information in a noncontact manner by using a laser beam, and an optical disc apparatus (an optical disc drive) which is capable of recording and reproducing information in/from an optical disc. Optical discs with several kinds of recording density called CD and DVD have become popular.

Recently, an ultra-high density optical disc HD (High Density) DVD (hereinafter abbreviated as HD DVD) using a laser beam with a blue or purple wavelength to record information to increase the recording density, has been put to practical use.

It is inefficient from the viewpoint of cost and installation place to prepare a different optical disc apparatus (a disk drive) for each of various types of optical disc. An optical disc apparatus is required to be capable of recording, reproducing and erasing information on/from optical discs of two or more standards.

A laser beam with a wavelength of 785 nm for example is used for recording, reproducing and erasing information on/from a CD standard optical disc that is already very popular. The wavelength of a laser beam used for a DVD standard disc is 655 nm, for example. The wavelength of a laser beam used for recording, reproducing and erasing information on/from a HD-DVD standard disc is 400 to 410 nm.

An optical disc apparatus includes a light transmitting system to radiate a laser beam with a fixed wavelength to a predetermined position on an optical disc (a recording medium), a light-receiving system to detect a laser beam reflected by an optical disc, a mechanism control (servo) system to control the operations of the light transmitting system and light-receiving system, and a signal processing system which supplies recording information and an erase signal to the light transmitting system, and reproduces recorded information from a signal detected by the light-receiving system.

The light transmitting system and light-receiving system include a semiconductor laser element (laser diode), and an object lens which condenses a laser beam from a laser diode on the recording surface of an optical disc and captures a laser beam reflected by an optical disc, which are formed as one unit called an optical head or optical pickup (head).

However, it increases the size and cost of an optical disc drive to prepare different optical heads for each wavelength of laser beam (optical disc standard) for recording or reproducing information in/from several standard optical discs.

In the above background, many proposals have been made to output laser beams with different wavelengths with a single optical head or optical pickup.

For example, Japanese Patent Application

Publication (KOKAI) No. 2003-303438 proposes an optical pickup having a first light source to generate light with a first wavelength, a second light source to generate light with a second wavelength different from the first wavelength, and an optical adjustment element to adjust optical axes of the lights from the light sources. In this optical pickup, the lights from the light sources can be condensed on the information recording surface of an optical disc of two or more standards with different recording density through the same optical path, and a binary blazed grating is used as an optical axis adjustment element.

However, it is known that the amount of transmission light is different according to the wavelengths of light to transmit in an optical element such as a binary blazed grating described in the above Publication. Besides, the position of image forming is different for each wavelength, when a reflected laser beam reflected on the recording surface of an optical disc is guided to a photodetector in a light-receiving system.

Therefore, in a system which receives laser beams with all wavelengths through a single photodetector provided with multiple light-receiving (detection) areas, the number of detection areas is increased as the intervals among the detection areas becomes different according to the wavelengths of laser beam, and the size of a photodetector is increased. This means an increase of a noise component included in the detection output (an S/N ratio is decreased).

The optical intensity difference of a reflected laser beam for each wavelength (the difference of amount of light transmitted through an optical element) is very large, and design of a signal processing circuit (amplifier) in a later stage becomes very difficult.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of an optical disc apparatus in accordance with an embodiment of the invention;

FIG. 2 is an exemplary diagram showing an example of an optical head (PUH) of the optical disc apparatus shown in FIG. 1, according to an embodiment of the invention;

FIG. 3 is an exemplary diagram showing a relation between wavefront splitting by an optical diffraction element and an detection area of photodetector in the optical head shown in FIG. 2, according to an embodiment of the invention; and

FIG. 4 is an exemplary diagram showing an example of the function of the optical diffraction element in the optical head shown in FIG. 2, according to an embodiment of the invention.

### DETAILED DESCRIPTION

Various embodiments according to the invention will be described hereinafter with reference to the accompanying drawings. In general, according to one embodiment of the invention, an optical head unit which is configured to provide a reproduce signal when reproducing information from a recording medium of a corresponding standard by selectively using laser beams with different wavelengths, an optical diffraction element is provided, in which the grooves of a binary diffraction grating mainly for a laser beam with a wavelength of 655 nm and a blazed diffraction grating mainly for a laser beam with a wavelength of 405 nm are defined substantially parallel, and the reflected laser beams of the laser beams with respective wavelengths reflected by a corresponding optical disc are guided to a substantially the same detection area or detection areas positioned very close to one another in a photodetector.

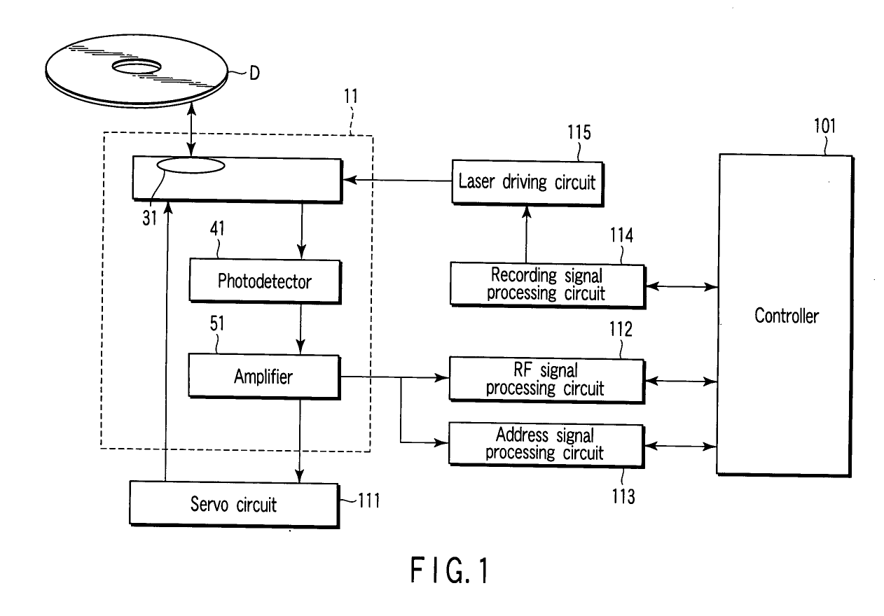

According to an embodiment, FIG. 1 shows an example of the configuration of an information recording/reproducing apparatus (an optical disc apparatus), to which the embodiments of the invention are applicable.

An optical disc apparatus 1 shown in FIG. 1 can record or reproduce information on/from an optical disc D, by condensing a laser beam with a predetermined wavelength explained hereinafter from an optical pickup (PUH actuator) 11 on an information recording layer of an optical disc D corresponding to an optional kind (standard) explained hereafter. The optical disc D is a disc of CD or DVD standard, or a HD (high density) DVD disc with the recording density increased to higher than the CD and DVD standards.

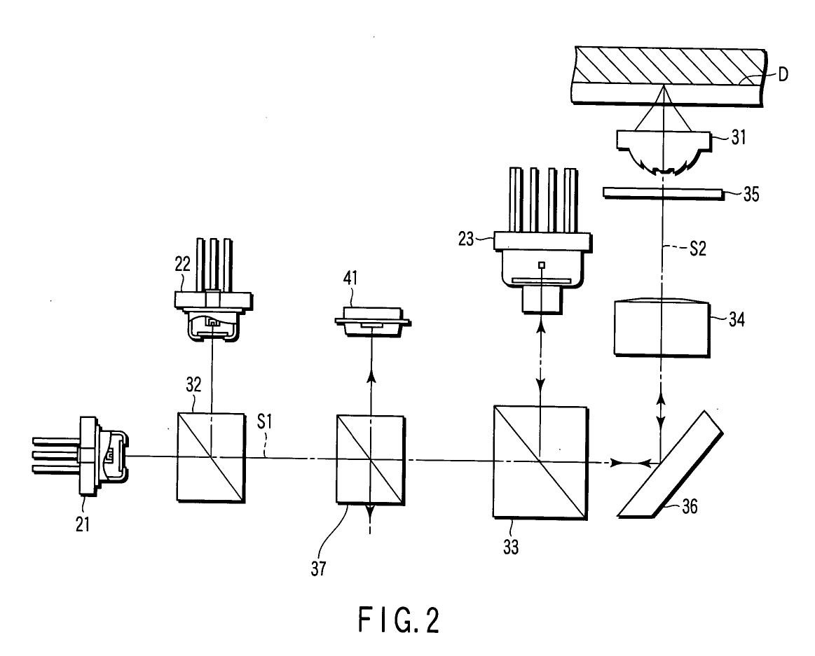

The PUH 11 can output any one of optical beams with first wavelength (405 nm), second wavelength (655 nm) and third wavelength (785 nm), according to the kind of a mounted optical disc D, as explained in a later paragraph with reference to FIG. 2. The PUH 11 also detects a reflected laser beam reflected on a not-shown information-recording surface of the optical disk D, and outputs an output signal usable for reproducing information already recorded.

Specifically, the reflected laser beam reflected by the optical disc D is detected by a photodetector 41 of the PUH 11, and converted to an output signal with the size changed corresponding to the intensity of the light. The output signal of the photodetector 41 is amplified to a predetermined level by an amplifier 51, and output to a pickup servo circuit 111, RF signal processing circuit (output signal processing circuit) 112 and address signal processing circuit 113 which are connected to a controller (main control unit) 101.

The servo circuit 111 generates a focus servo signal (to control the difference in the distance between a recording layer of the optical disc D and an object lens, with respect to the focal position of an object lens) for an object lens of the PUH 11, and a tracking servo signal (to control the position of an object lens in the direction of crossing the track of the optical disc D), as explained in detail in a later paragraph with reference to FIG. 2. These signals are output to a not-shown focus actuator and tracking actuator, respectively.

The RF signal processing circuit 112 takes out user data and management information from a signal detected and reproduced by a photodetector. The address signal processing circuit 113 takes out address information, that is, information indicating a track or sector of the optical disc D opposed now to the object lens of the PUH 11. The taken-out information is output to the controller 101.

The controller 101 controls the position of the PUH 11 to read data such as user data at a desired position, or to record user data and management information at a desired position, based on the address information.

The controller 101 instructs an optical intensity of a laser beam to be output from a laser element (LD) when recording or reproducing information on/from the optical disc D. According to the instruction of the controller 101, the data recorded at an address of a desired position (or sector) can be erased.

When recording information on the optical disc D, (under the control of the controller 101) a recording signal processing circuit 114 supplies the laser driving circuit (LDD) 115 with a recording data, or a recording signal modulated to a recording waveform signal suitable for recording on the optical disc D. Therefore, the laser element of the PUH 11 emits a laser beam with the intensity changed according to recording information, corresponding to a laser driving signal output from the LDD 115. Information is recorded on the optical disc D by this.

FIG. 2 shows an example of the configuration of PUH (an optical pickup, or an optical head) of the optical disc apparatus shown in FIG. 1.

The PUH 11 includes a first light source 21 that is a semiconductor laser element, for example. The wavelength of an optical beam emitted from the first light source 21 is 400 to 410 nm, preferably 405 nm. The PUH 11 also includes a second light source 22 that is a semiconductor laser element, for example. The wavelength of an optical beam emitted from the second light source 22 is preferably 655 nm. The PUH 11 also includes a third light source 23 that is a semiconductor laser element, for example. The wavelength of an optical beam emitted from the third light source 23 is preferably 785 nm.

At a predetermined position of the PUH 11 opposite to the optical disc, an object lens 31 is provided. The object lens condenses the laser beam emitted from one of the first to third light sources 21 to 23 according to the kind of the optical disc D set in the optical disc apparatus 1 shown in FIG. 1, on a not-shown recording surface of the optical disc D, and captures the reflected laser beam reflected on the recording surface. The object lens 31 is a lens applicable to three wavelengths and capable of providing a predetermined numerical aperture (NA) for each laser beam output from the first to second laser elements 21 and 23. The object lens 31 is made of plastic, and has a numerical aperture NA of 0.65 for a laser beam with a wavelength of 405 nm, and 0.6 for a laser beam with a wavelength of 655 nm, for example.

Between the first to third laser elements (light sources) 21 to 23 and the object lens 31, the first optical coupling prism 32, second coupling prism 33, collimator lens 34, and optical diffraction element 35 composed of a polarization dependent diffraction element formed on an optical glass with a predetermined thickness are arranged in this order from the first laser element 21. The optical diffraction element 35 may be formed integrally with a known λ/4 plate. (In the following explanation, a λ/4 plate is provided integrally with the optical diffraction element 35 in this example.) Usually, in designing an optical path or for decreasing the thickness of the PUH 11, a mirror 36 for bending the optical path (usually called a rising mirror) is provided between the collimator lens 34 and optical diffraction 34 or between the collimator lens 34 and second optical coupling prism 33.

Between the first optical coupling prism 32 and second optical coupling prism 33, a beam splitter 37 is provided. The beam splitter transmits most laser beam traveling from the first optical coupling prism 32 to the second optical coupling prism 33 (namely, from the first light source 21 to the optical disc D), and reflects the reflected laser beam reflected on the recording surface of the optical disc D at a predetermined ratio.

In the traveling direction of the reflected laser beam reflected by the beam splitter 37, a photodetector 41 is provided. The photodetector detects a reflected laser beam reflected on the recording/reproducing surface of the optical disc D, and outputs an electric signal corresponding to the light intensity of the reflected laser beam.

The first coupling prism (dichroic prism) 32 transmits the laser beam L1 with a wavelength of 405 nm (400 to 410 nm) emitted from the first light source or semiconductor laser element 21 for HD DVD, and reflects the laser beam L2 with a wavelength of 655 nm (640 to 670 nm) emitted from the second light source or the semiconductor laser element 22 for DVD, thereby coupling both laser beams on the same optical path. The first optical coupling prism 32 is demanded to transmit the laser beam L1 from the first light source 21 without substantially decreasing the intensity. Thus, the reflectivity is 0% (except the reflection on the base material surface) for a laser beam with a wavelength shorter than 655 nm, for example. Therefore, a film characteristic inverting wavelength band (wavelength band to invert the characteristics of reflection and transmission) is defined here preferably to 405 to 655 nm. It is known that a wavelength of a laser beam output from a laser element is usually fluctuated by 10 nm/5° C., for example, by fluctuations in the temperature of a laser element and ambient temperature. A central wavelength of an output laser beam is different by individuals. Therefore, actually, a wavelength area of film characteristic inverting wavelength band is of course defined including the influence of the temperature fluctuations.

Contrarily, the second optical coupling prism 33 (trichroic prism) must transmit the laser beams from the first and second light sources 21 and 22 (reflect only the laser beam with a wavelength of 785 nm (775 to 795 nm) from the third light source 23). Therefore, the reflectivity is 0% (except the reflection on the base material surface) for a laser beam with a wavelength shorter than 785 nm, for example. Therefore, a film characteristic inverting wavelength band (wavelength band to invert the characteristics of reflection and transmission) is defined preferably to 655 to 785 nm. Of course, it is known that a wavelength of a laser beam output from a laser element which outputs a laser beam of a wavelength of 785 nm is also fluctuated by 10 nm/5° C., for example, by fluctuations in the temperature of a laser element and ambient temperature. A central wavelength of an output laser beam is different by individuals. Therefore, actually, a wavelength area of film characteristic inverting wavelength band is of course defined including the influence of the temperature fluctuations.

Next, a detailed explanation will be given on radiation of a laser beam from the PUH shown in FIG. 2, and a laser beam from an optical disc.

The laser beam L1 emitted from the first light source 21 is guided to a rising mirror 36 through the first optical coupling prism 32, beam splitter 37 and second optical coupling prism 33. The laser beam L1 guided to the rising mirror 36 is reflected by the rising mirror 36, changed in the traveling direction, and guided to the object lens 31 through the collimator lens 34 and optical diffraction element (HOE) 35. The object lens 31 condenses the laser beam L1 on a not-shown recording surface of the optical disc D.

The laser beam L2 with a wavelength of 655 nm emitted from the second light source 22 is reflected by the first optical coupling prism 31, and guided to the rising mirror 36 through the beam splitter 37 and second optical coupling prism 33. The laser beam L2 is reflected by the rising mirror 36 is condensed on a not-shown recording surface of the optical disc D by the object lens 31, like the first laser beam L1.

The laser beam L3 with a wavelength of 785 nm emitted from the third light source 23 is reflected by the second optical coupling prism 33, and guided to the rising mirror 36. The laser beam L3 is reflected by the rising mirror 36, and condensed to a not-shown recording surface of the optical disc D by the object lens 31, like the first L1.

The reflected laser beam (R1 to R3) reflected on the recording surface of the optical disc D is captured by the object lens 31 and returned to the optical diffraction element 35.

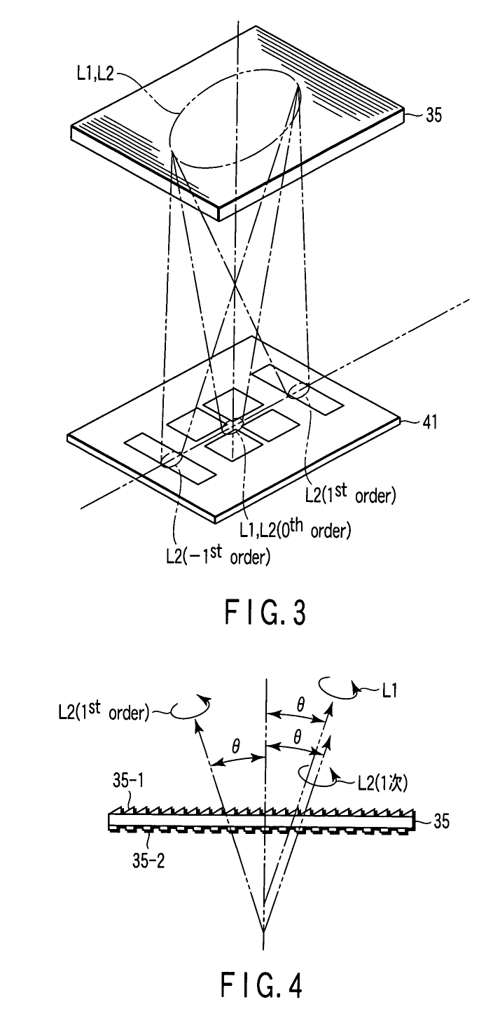

The reflected laser beam (L1 to L3) returned to the optical diffraction element 35 is wavefront split to a predetermined number detectable by a light-receiving area (detection area) previously given a predetermined interval and positional relationship on the light-receiving plane of the photodetector 41, returned to the collimator lens 34, and reflected to the beam splitter 37 by the rising mirror 36, as explained later with reference to FIG. 3.

The laser beams L1 and L2 from the first laser element 21 reflected on the recording surface of the optical disc D is reflected by the beam splitter 37, and forms images on the light-receiving plane of the photodetector 41. Contrarily, the laser beam L3 is reflected by the surface of a wavelength selection film 33a of the second optical coupling prism 33, and guided to a not-shown photodetector provided integrally with the third light source 23.

The reflected laser beam (L1, L2) guided to the light-receiving plane of the photodetector 41 are detected by a not-shown light-receiving area divided into four by two dividing lines orthogonal to each other, and output as an output signal of the largeness corresponding to the light intensity. In addition to the four light-receiving areas, a light-receiving area mainly for generation of a tracking servo signal may be provided.

Though not described in details, an output signal (reflected laser beam detection output) from each detection area of the light-receiving plane of the photodetector 41 is used for generation of a focus servo signal and tracking servo signal described before, by predetermined subtraction and addition processing.

FIG. 4 shows a function of an optical diffraction element.

As shown in FIG. 4, the optical diffraction element 35 is a multi-diffraction grating composed of a first diffraction pattern 35-1 mainly for diffracting a laser beam with a wavelength of 405 nm at an angle of θ, and a second diffraction pattern 35-2 mainly for diffracting a laser beam with a wavelength of 655 nm at an angle of θ, formed integrally on a base material (quartz) with a predetermined thickness. The first diffraction pattern 35-1 is a blazed grating, and the second diffraction pattern 35-2 is a binary grating (having a flat grove, with the groove surface parallel to the base material surface). The diffraction patterns are formed on both sides of the base material by a hologram structure, for example. Of course, each pattern may be independently formed on an independent base material. In this time, as seen from FIG. 4, the direction of the grooves of each diffraction pattern is defined substantially parallel.

The first and second diffraction patterns 34-1 and 35-2 can transmit a laser beam with a wavelength of 405 nm by optimizing the pitch. The second diffraction pattern 35-2 can transmit a laser beam with a wavelength of 405 nm almost as it is. The first diffraction pattern 35-1 can transmit a laser beam with a wavelength of 655 nm almost as it is. The diffraction patterns 35-1 and 35-2 do not affect a laser beam with a wavelength of 785 nm (except for a little insertion).

By setting the angle θ of diffracting a laser beam in the first and second diffraction patterns 35-1 and 35-2 to substantially equal in the respective wavelengths of laser beam, the detection areas on the light-receiving plane of the photodetector 41 can be positioned substantially equal with respect to the respective laser beams. Namely, at least one of the previously divided light-receiving areas of the photodetector 41 is the same for a laser beam diffracted by the first diffraction pattern (blazed) 35-1 and a laser beam diffracted by the second diffraction pattern (binary) 35-2 (or, formed closely to the extent that at least a part of optical spot is overlaid).

Therefore, superimposition of a noise component is decreased before the output of each detection area (photocell) is amplified by the amplifier 51 (refer to FIG. 1) provided in a later stage, and a stable reproducing signal with a high S/N (signal-to-noise) ratio can be obtained.

As one of the factors of the improved S/N ratio, the size (area) of each detection area (photocell) can be decreased as a result of making laser beams with different wavelengths condensable at substantially the same position or at very close positions, by combining the above-mentioned two diffraction gratings.

Concerning the laser beam L2 from the second light source 22 passing through the binary diffraction grating 35-2, a remaining component (beam spot) of a 1^{st}-order diffraction light can be obtained on the opposite side (at the position of −θ) at the angle of θ, regarding a 0^{th}-order light as an axis of symmetry. Therefore, by using the remaining component (½ of 1^{st}-order diffraction light), application of obtaining an RF signal, for example, can be expected.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

For example, a blazed type and a binary type of optical diffraction element may be independently provided. An optical diffraction element can be used also as a phase plate (λ/4 plate) to rotate the polarization direction of a laser beam, by setting the thickness of a base material of optical diffraction element optimum. In this case, it is preferable to place a λ/4 plate in the object lens 31.

What is claimed is:

1. An optical head unit comprising:
an object lens which captures light reflected on the recording/reproducing surface of a recording medium;
an optical diffraction element which includes a
first diffraction grating to diffract the light captured by the object lens in a direction predetermined according to the wavelength of the light, and a second diffraction grating which has a diffraction pattern different from the first diffraction grating and diffracts the light in a direction predetermined according to the wavelength of the light; and
a photodetector which detects the light diffracted by the optical diffraction element at a position predetermined according to the diffraction angle, and generates an output signal with a largeness corresponding to the intensity of the light.

2. The optical head unit according to claim 1, wherein the first diffraction grading of the optical diffraction element is a blazed type, and the second diffraction grating of the optical diffraction element is a binary type.

3. The optical head unit according to claim 1, wherein the extending directions of grooves of the first and second diffraction gratings are defined parallel to each other.

4. The optical head unit according to claim 2, wherein the extending directions of grooves of the first and second diffraction gratings are defined parallel to each other.

5. The optical head unit according to claim 1, wherein the photodetector has previously divided light-receiving areas, and at least a part of the light-receiving areas is common in the lights diffracted by the first diffraction grating and second diffraction grating.

6. The optical head unit according to claim 2, wherein the photodetector has previously divided light-receiving areas, and at least a part of the light-receiving areas is common in the lights diffracted by the first diffraction grating and second diffraction grating.

7. The optical head unit according to claim 3, wherein the photodetector has previously divided light-receiving areas, and at least a part of the light-receiving areas is common in the lights diffracted by the first diffraction grating and second diffraction grating.

8. An optical head unit comprising:
a first light source which outputs light with a first wavelength;
a second light source which outputs light with a second wavelength different from the wavelength of the light output from the first light source;
a lens which takes in the light emitted from the first and second light sources, and reflected on the recording layer of a recording medium;
a first diffraction grating which diffracts the lights emitted from the first and second light sources and taken in by the lens, at an angle predetermined according to the wavelength of one of the lights.
a second diffraction grating which defines the lights emitted from the first and second light sources and taken in by the lens, at an angle predetermined according to the wavelength of one of the lights, and related to the angle of diffracting the light with the first wavelength; and
a photodetector which detects the light diffracted by the first and second diffraction gratings, and outputs an output signal with a largeness corresponding to the intensity of the light.

9. The optical head unit according to claim 8, wherein the first and second diffraction gratings are integrally formed.

10. The optical head unit according to claim 8, wherein the first diffraction grading is a blazed type, and the second diffraction grating is a binary type.

11. The optical head unit according to claim 9, wherein the first diffraction grading is a blazed type, and the second diffraction grating is a binary type.

12. The optical head unit according to claim 8, wherein the extending directions of grooves of the first and second diffraction gratings are defined parallel to each other.

13. The optical head unit according to claim 9, wherein the extending directions of grooves of the first and second diffraction gratings are defined parallel to each other.

14. The optical head unit according to claim 10, wherein the extending directions of grooves of the first and second diffraction gratings are defined parallel to each other.

15. The optical head unit according to claim 11, wherein the extending directions of grooves of the first and second diffraction gratings are defined parallel to each other.

16. The optical head unit according to claim 8, wherein the photodetector has previously divided light-receiving areas, and at least a part of the light-receiving areas is common in the lights diffracted by the first diffraction grating and second diffraction grating.

17. An information recording/reproducing apparatus comprising:
an optical head unit; and
a signal reproducing circuit which takes out a signal component corresponding to information from a signal detected by the photodetector, to reproduce the information recorded in a recording medium.

18. The information recording/reproducing apparatus according to claim 17, wherein the output of the signal processing circuit is used as a control signal to control the distance between an object lens of the optical head unit and the recording layer of a recording medium to be identical to a focal position of the object lens.

19. The information recording/reproducing apparatus according to claim 17, wherein the first diffraction grading of the optical diffraction element of the optical head unit is a blazed type, and the second diffraction grating of the optical diffraction element is a binary type.
